(19) United States
(12) Patent Application Publication
(10) Pub. No.: US 2025/0050432 A1
(43) Pub. Date: Feb. 13, 2025

(54) DRILL WITH IMPROVED CHIP EVACUATION

(71) Applicant: AB SANDVIK COROMANT, Sandviken (SE)

(72) Inventors: Wilhelm FRIBERG, Stockholm (SE); Lucas NILSSON, Lulea (SE)

(21) Appl. No.: 18/719,875

(22) PCT Filed: Dec. 14, 2022
(86) PCT No.: PCT/EP2022/075523

§ 371 Date: Jun. 14, 2024

(30) Foreign Application Priority Data
Dec. 15, 2021 (EP) 21214765.6

(51) Int. Cl. B23B 51/02

(52) U.S. Cl. CPC B23B 51/02; B23B 2251/40

(57) ABSTRACT

A drill includes a front and rear end, a shaft extending axially rearwardly from the front end, at least one cutting insert releasably mounted at the front end, a first and second chip flute in an envelope surface of the shaft, a coolant chamber inside a shank, and a first and second coolant channel extending from the front end of the coolant chamber and terminating at the drill front end. The first coolant channel is associated with the first chip flute and the second coolant channel is associated with the second chip flute. The coolant chamber includes a flow control element movable in response to a flow restriction between a neutral position, in which coolant flow is distributed substantially equally to the first and second coolant channels, and an active position, in which the flow control element directs the coolant flow at least mainly to one of the coolant channels.

### TECHNICAL FIELD

The present invention relates to a drill for metal cutting machining, more particular to a drill for metal cutting machining with improved chip evacuation.

### BACKGROUND

Drilling is one of the most common machining operations in modern manufacturing and provides a reliable and cost effective method to make holes with high precision. During the drilling operation it is important to use a coolant to cool the drill and the work piece and thus prolong the lifetime of the drill and to improve the quality of the hole. The coolant passes through coolant channels in the drill which terminate at the front end of the drill. The coolant also evacuates chips produced in the drilling operation from the drill area via chip flutes in the envelope surface of the drill.

A problem that may occur during drilling, especially when drilling difficult to machine materials, such as, for example, Titanium alloys, is a phenomenon called chip jamming. Chip jamming is when machined chips gets stuck in a chip flute, between the surface of the chip flute and the wall of the drilled hole, thus to some extent or completely blocking the chip flute. Chip jamming is detrimental to the drilling process and may lead to a damaged drill tool and to an impaired quality of the drilled hole.

Therefore, it is a need for improvements in a drill for metal cutting machining such that chip jamming can be prevented or, if chip jamming has occurred, loosen the jammed chips to again achieve an unhindered flow in the chip flutes.

It is therefore an object of the present invention to present an improved drill for metal cutting machining with a decreased risk of chip jamming.

### SUMMARY

According to the present invention, the above mentioned object is achieved by means of a drill for metal cutting machining having the features defined in claim 1.

The drill for metal cutting machining according to the present invention comprises: a central rotation axis defining a longitudinal direction of the drill and around which the drill is rotatable, an axially front end, an axially rear end, an envelope surface extending between the front end and the rear end, a shaft extending axially rearward from the front end, a shank extending axially forward from the rear end, at least one cutting insert releasably mounted at the front end, a first and a second chip flute in the envelope surface of the shaft, a coolant chamber inside the shank, a first and second coolant channel extending from the front end of the coolant chamber and terminating at the front end of the drill. The first coolant channel is associated with the first chip flute and the second coolant channel is associated with the second chip flute. The coolant chamber comprises a flow control element, which is movable between a neutral position, in which coolant flow is distributed equally to the first and second coolant channels, and an active position, in which the flow control element directs the coolant flow at least mainly to one of said coolant channels, and that the flow control element is arranged to move from said neutral position to said active position in response to a flow restriction in one of the chip flutes, such that the coolant is directed at least mainly to said one coolant channel associated with the chip flute having a flow restriction.

The present inventors have realized that this configuration alleviates the problem with chip jamming. When chip jamming occurs in the first chip flute the flow of coolant in the first chip flute will be restricted. This flow restriction will lead to an increase in the coolant pressure in the first coolant channel associated with the first chip flute. This creates a pressure difference between the first coolant channel and the second coolant channel. The pressure difference moves the flow control element from a neutral position to an active position in which the flow in the second coolant channel is restricted. This disrupts, or drastically reduces, the coolant flow in the second channel and in the second chip flute. The reduced flow in the second coolant channel implies that the pressure of the coolant in the first coolant channel and first chip flute increases. The increased pressure in the first chip flute results in that the jammed chips in the first chip flute are flushed away thus removing the chip jam from the first chip flute. Preferably, the flow in the restricted coolant channel is reduced at least 30% when the flow control element is in an active position, more preferably at least 50% of the flow is restricted, even more preferably at least 70% of the flow is restricted, even more preferably at least 90% of the flow is restricted, and most preferably approximately 100% of the flow is restricted.

Associated with here means that a majority of the coolant flow from the first coolant channel reaches the first chip flute and the majority of the coolant flow from the second coolant channel reaches the second chip flute. The reason for this may be due to different design alternatives. That the first coolant channel terminates close to or in the first chip flute, that the outlet of the first coolant channel is directed towards the first chip flute or that the rotation of the drill implies that most of the coolant from the first coolant channel reaches the first chip flute. The same applies for the second coolant channel and the second chip flute.

Many different types of coolant can be used, for example a water-based coolant or an oil-based coolant.

According to one embodiment, the flow control element automatically moves from the neutral position to an active position when there is a pressure difference in the coolant between the first and the second coolant channel.

This configuration ensures that the flow control element moves from the neutral position to an active position, without any outside assistance or actuators, when there is a chip jam in one of the chip flutes since a chip jam in one of the chip flutes will lead to an increased pressure in the coolant channel associated with the affected chip flute.

According to one embodiment, the flow control element moves back to the neutral position when the flow restriction in one of the chip flutes is removed.

This configuration implies that the flow of coolant will again be evenly distributed between the first and second coolant channel when the chip jam has been removed. This ensures even distribution between the first and second chip flute to obtain best possible cooling and continuous evacuation of chips.

According to one embodiment, the flow control element is entirely mechanical. This configuration is suitable and durable for the harsh conditions encountered when drilling in metallic materials. Flow control elements comprising electrical parts would be more susceptible to failure during the drilling operation.

According to one embodiment, the flow control element is positioned between the rearward axial extensions of the first and second coolant channel when the flow control element is in the neutral position

With this configuration the flow control element is suitably positioned to be able to move to restrict the flow in either the first coolant channel or the second coolant channel.

According to one embodiment, the flow control element is a pendulum rotatable around an axle.

This configuration is cost effective and having the flow control element in the form of a pendulum rotatable around an axle ensures that the flow control element automatically moves from a neutral position to an active position when there is a pressure difference between the first and second coolant channel.

According to one embodiment, the pendulum is hinged to the axle by a hole at the rear end of the pendulum and that the axle is partially threaded and fastened to the shank by a threaded hole in the shank.

This configuration is cost effective and ensures simple installation and replacement of the pendulum.

According to one embodiment, the hole in the shank is positioned on the rotation axis, perpendicular to the rotation axis and perpendicular to a line passing through the center of the first coolant channel and the center of the second coolant channel at the rear ends of the first and second coolant channel.

This configuration ensures that the pendulum can swing in directions to cover either the first or the second coolant channel to restrict the flow in respective channel.

According to one embodiment, the coolant chamber, in a cross-section perpendicular to the rotation axis, has a width approximately equal to the distance between the radially outermost parts of the rear ends of the first and second coolant channels.

According to one embodiment, the coolant chamber, in a cross-section perpendicular to the rotation axis, has a thickness approximately equal to the diameter of the first and second coolant channels at the rear ends of the first and second coolant channels.

This configuration ensures that the pendulum at its end points of its swing plane cover either the first or the second coolant channel to restrict the flow in respective channel.

The width of the coolant chamber may also be larger than the diameter of the first and second coolant channels at the rear ends of the first and second coolant channels.

According to one embodiment, the pendulum has its front end approximately at the front end of the coolant chamber.

According to one embodiment, the cross-sectional area of the front end of the pendulum is larger than the cross-sectional area of the first and the second coolant channel at the rear ends of the first and the second coolant channel.

With this configuration the coolant flow in the first or the second coolant channel is effectively restricted when the pendulum is in an active position.

According to one embodiment, the pendulum has a thickness that is approximately equal to the thickness of the coolant chamber.

This configuration further improves the restriction of coolant flow when the pendulum is in an active position.

According to one embodiment, the drill has two axially extending arms at its front end, the arms spaced apart about the rotation axis to define a jaw, the cutting insert releasably mounted within the jaw between the arms.

With this configuration a single drill body can hold a variety of cutting inserts with varying geometries, allowing greater flexibility for optimum performance across multiple materials and applications.

According to one embodiment, the drill has a central cutting insert releasably mounted in an insert seat at the front end of the drill and a peripheral cutting insert releasably mounted in an insert seat at the front end of the drill.

This configuration ensures efficient drilling and allows the usage of indexable cutting inserts which improves the economy of the drill operation.

Further advantages of the present invention will appear from the description following below.

### LIST OF DRAWINGS

Embodiments of the invention will now be described in detail with regard to the annexed drawings, in which:

FIGS. 1a, b are perspective views of the drill according to an embodiment of the present invention.

FIG. 2 is a side view of the drill shown in FIG. 1 with interior parts of the drill shown in dashed lines and rear parts of the drill cut away to show the interior. This figure shows the flow control element in its neutral position.

FIG. 2a is a part of the same side view as in FIG. 1 but with the flow control element in an active position.

FIG. 3 is an end view of the rear end of the drill shown in FIG. 1 with the flow control element removed.

FIG. 4 is a perspective view of a flow control element in the form of a pendulum according to an embodiment of the invention.

FIG. 4a is a side view of the pendulum shown in FIG. 4.

FIG. 4b is a side view of the pendulum shown in FIG. 4.

FIG. 4c is a front end view of the pendulum shown in FIG. 4.

FIGS. 5a, b are perspective views of another embodiment of the invention.

### DETAILED DESCRIPTION OF EMBODIMENTS

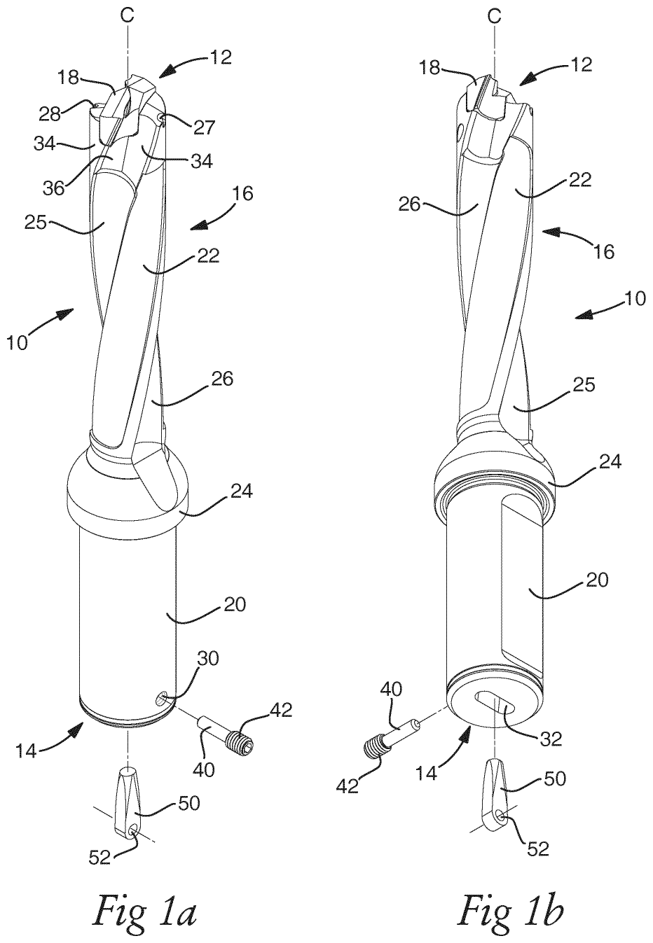

Reference is made to FIG. 1a-1b, which show a drill according to an embodiment of the invention. Such a drilling tool is a device which is adapted for use in metal or composite cutting operations, primarily drilling operations, but the drilling tool can also be used for helical interpolation, boring, plunging and turning operations. The drilling tool is arranged to be mounted or connected to a machine tool (not shown), such as a CNC machine, either directly or indirectly by one or more tool holders, to a tool spindle of the machine tool.

The drill, generally designated 10, has a central rotation axis (C) around which the drill is rotatable. The drill further has a front end 12, a rear end 14 and an envelope surface 16 that extends between the front end 12 and the rear end 14.

In the following description the front end of an element refers to the parts of the element that is closest to the front end 12 of the drill 10 when the element is mounted in the drill. Correspondingly, the rear end of an element refers to the parts of an element that is closest to the rear end 14 of the drill 10 when the element is mounted in the drill. Further, an axial direction refers to a direction parallel to the rotation axis (C) and a radial direction refers to a direction perpendicular to the rotation axis (C).

The drill 10 further has a shaft 22 extending axially rearward from the front end 12 of the drill 10 to a collar 24. A shank 20 extending axially forward from the rear end 14 of the drill 10 to the collar 24. The shank 20 is for attaching the drill 10 to a rotatable tool holder (not shown). The shaft 22 includes first 25 and second chip flutes 26 for transporting coolant and chips away from the bottom of a drilled hole. The first 25 and second chip flutes 26 preferably extends all the way to the collar 24 which directs coolant and chips away from the hole. The first 25 and second chip flutes 26 are helically shaped around the shaft 22 for efficient cooling and transportation of chips. The front of the collar 24 has a generally conical shape and has a diameter that is larger than the diameter of the shaft 22 and larger than the diameter of the shank 20, to efficiently direct chips away from the hole and away from the rotatable tool holder. The rear side of the collar is perpendicular to the rotation axis to act as a stop when inserting the shank 20 in the rotatable tool holder.

Axially extending arms 34, forming a jaw 36 between them, are positioned at the front end 12 of the drill. A cutting insert 18 is mounted in the jaw 36 by threaded screws (not shown). The cutting insert 18 extends across the whole diameter of the drill 10 and comprises cutting edges that meet at the center of the front end of the cutting insert 18 at the rotation axis (C) of the drill 10. The cutting insert 18 further comprises chip channels that connect to the chip flutes 25, 26 of the drill 10. The drill 10 is thus what is usually called an exchangeable head drill.

A coolant chamber 32 is positioned at the rear end 14 of the drill. The rear end of the coolant chamber 32 is connected to a coolant inlet (not shown). A flow control element 50, here in the form of a pendulum 50, can be fastened in the coolant chamber by an axle 40 through a hole 52 at the rear end of the pendulum 50. The axle 40 is inserted into a threaded hole 30 in the shank 20 and through the hole 52 in the pendulum. A threaded end 42 of the axle 40 engages the threaded hole 30 in the shank 20 to ensure that the axle is secured.

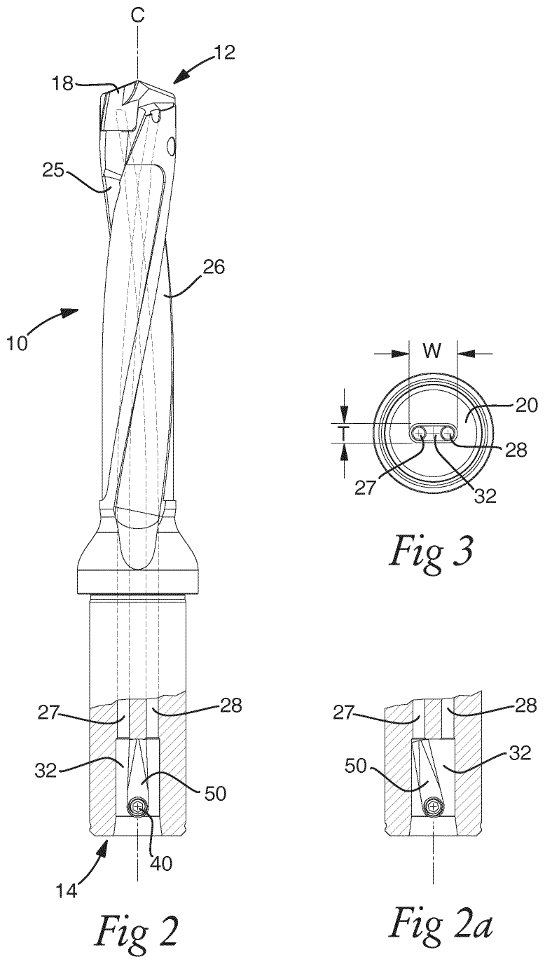

Referring now to FIG. 2 showing some of the features inside the drill 10. A first 27 and second coolant channel 28 starts at the front end of the coolant chamber 32 and terminates at, or close to, the front end 12 of the drill 10. Terminates in here means that the first and second coolant channels have their outlets at, or close to, the front end 12. Coolant will pass through the first and second coolant channels 27, 28 to cool the drill 10, the cutting insert 18 and the work piece that is being drilled. The coolant will further flush drilled chips away from the bottom of the drilled hole through the first and second chip flute 25, 26. The first and second coolant channels 27, 28 are preferably twisted in the drill 10.

The first coolant channel 27 is said to be associated with the first chip flute 25. That means that the first coolant channel has its outlet close to or in the first chip flute 25 and/or has its outlet directed towards the first chip flute 25. A majority of the coolant that flows in the first coolant channel 27 will pass through the first chip flute 25. The same applies for the second coolant channel 28 and the second chip flute 26.

The coolant chamber occupies approximately 40% of the length of the shank 20 and the width W of the coolant chamber 32 is approximately 45% of the diameter of the shank 20.

In the coolant chamber 32 the mounted pendulum 50 is seen hinged on the axle 40. The axle 40 is positioned perpendicular to the rotation axis (C) and perpendicular to a line passing through the center of the first coolant channel 27 and the center of the second coolant channel 28 at the rear ends of the first and second coolant channels 27, 28. By this configuration the pendulum 50 will have a swing plane that reaches the rear ends of the first and second coolant channels 27, 28. FIG. 2 shows the pendulum in a neutral position positioned along the rotation axis (C) between rearward axial extensions of the first and second coolant channel 27, 28. FIG. 2b shows the pendulum in an active position where it restricts the flow in the first coolant channel 27.

The axle 40 is positioned at a distance from the rear end 14 of the drill 10 that is approximately equal to 25% of the length of the coolant chamber. The length of the pendulum 50 is such that the front end of the pendulum 50 extends approximately to, or very close to, the front end of the coolant chamber 32.

During drilling machined chips transported from the bottom of the drilled hole through the first and second chip flutes 25, 26 may get stuck, or jammed, between a chip flute and the wall of the drilled hole. If a chip gets jammed in the second chip flute 26 the flow of coolant will be restricted in that chip flute.

This leads to an increased pressure of the coolant in the second coolant channel 28 associated with the second chip flute 26. An increased pressure in the second coolant channel 28 leads to a pressure difference between the first coolant channel 27 and the second coolant channel 28. The pressure difference moves the pendulum from a neutral position to an active position where it restricts the flow in the first coolant channel 27. The restriction of flow in the first coolant channel leads to an increased flow and pressure in the second coolant channel 28 and the associated second chip flute 26 which will help alleviate the problem of the jammed chips in the second chip flute 26. When the chip jam in the second chip flute 26 is removed the pressure difference between the first 27 and second coolant channel 28 will disappear and the pendulum will again move to a neutral position thus creating an even distribution of coolant flow to the first 27 and second coolant channel 28 and to the first 25 and second chip flute 26.

The forces arising from the pressure of the coolant acting on the pendulum is much larger than the forces that arises on the pendulum due to the rotation of the drill 10. The pendulum 50 can therefore restrict the flow in either of the first 27 or second coolant channel 28 when there is a pressure difference between them and return to a neutral position when the pressure difference between the first 27 and second coolant channel 28 ceases. The pressure of the coolant when entering the coolant chamber 32 from the coolant inlet is between 5 to 70 bar. Most often pressures between 10 to 30 bar are used.

Referring now to FIG. 3 which shows the drill 10 from its rear end 14 with the pendulum 50 and axle 40 removed. The coolant chamber 32 is positioned at the radial centre of the drill and the first 27 and second coolant channels 28 are positioned equidistant from the rotation axis (C). The coolant chamber 32 has the shape of a slot in a cross-section perpendicular to the rotation axis (C), with semi-circles at its short ends. The coolant chamber 32 has a width W that is approximately the same, or slightly larger, than the distance between the radially outermost points of the first and second coolant channels 27, 28. The coolant chamber 32 has a thickness T that is approximately the same, or slightly larger, than the diameter of the first and second coolant channels 27, 28. This configuration ensures that the pendulum 50 effectively restricts the flow in the first 27 or the second coolant channel 28 when the pendulum is at one of its end points in its swing plane in an active position.

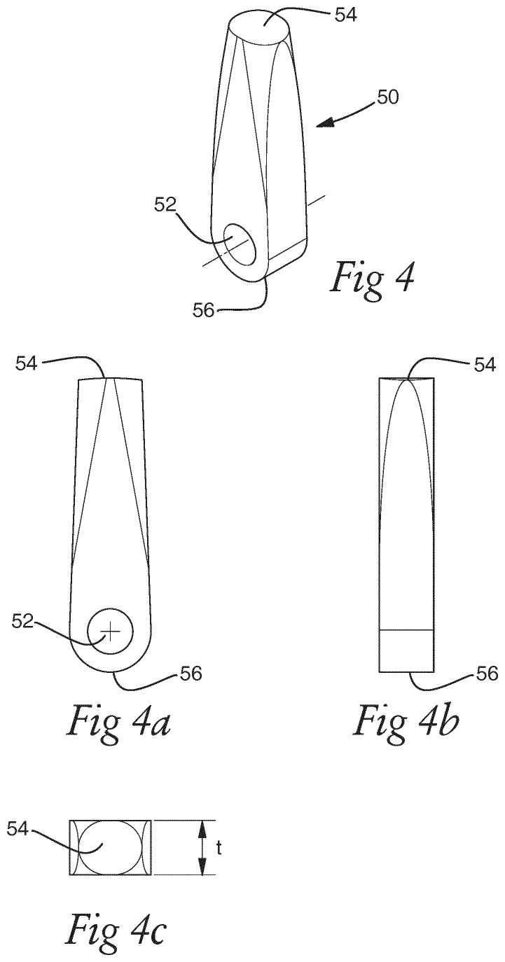

Referring now to FIG. 4 which shows the pendulum 50. The pendulum 50 is elongated and has a longer length in an axial direction than it is wide in a radial direction. The pendulum 50 is slightly wider close to its rear end than at its front end. Close to the rear end of the pendulum 50 a hole 52 for hinging the pendulum 50 to axle 40 is seen. The front end 54 of the pendulum 50 has a flat elliptical surface with an area that is larger than the area of either of the areas of the first 27 or the second coolant channel 28 at the rear end of the coolant channels. This ensures efficient restriction of flow in either of the first 27 or second coolant channel 28 when the pendulum 50 is in an active position. The pendulum 50 has a thickness t that is approximately the same size or slightly smaller than the thickness T of the coolant chamber 32 to ensure that the pendulum 50 swings within the coolant chamber 32 with ease and that it efficiently restricts the flow in the first 27 or second coolant channel 28 when the pendulum 50 is in an active position.

The rear end 56 of the pendulum 50 is curved to ensure a smooth flow of coolant around the pendulum 50 and to decrease stress in the pendulum 50. For the same reasons the sides of the pendulum 50 may be curved or beveled.

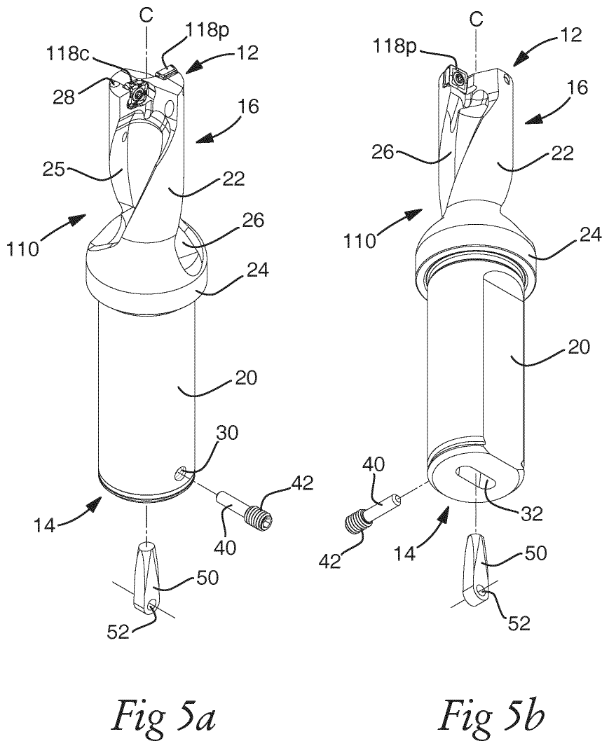

Referring now to FIG. 5 which shows another embodiment of the present invention. Same reference numerals designate the same features, as for the embodiments described above with reference to FIGS. 1-4. The drill 110 in FIG. 5 differs from the embodiment in FIG. 1 substantially only in the arrangement of cutting insert(s) at the front end of the drill. More specifically, at the front end of drill 110 two insert seats are positioned to accommodate a central insert 118c and a peripheral insert 118p where the central insert 118c is positioned closer to the rotation axis (C) than the peripheral insert 118p. These inserts 118c, 118p are usually indexable meaning that several different cutting edges can be used on the same insert 118c, 118p.

The tool bodies for both types of drills 10, 110 are single-piece bodies made from one piece of material, preferably tool steel. The cutting inserts 18, 118c, 118p used with both types of drills 10, 110 are preferably made of a hard metal such as cemented carbide. The pendulum 50 and the axle 40 are preferably made of a steel material.

The invention claimed is:

1. A drill for metal cutting machining having a central rotation axis defining a longitudinal direction of the drill and around which the drill is rotatable, the drill comprising:
an axially front end;
an axially rear end;
an envelope surface extending between the front end and the rear end;
a shaft extending axially rearward from the front end;
a shank extending axially forward from the rear end;
at least one cutting insert releasably mounted at the front end;
a first and a second chip flute in the envelope surface of the shaft;
a coolant chamber inside the shank; and
a first and second coolant channel extending from the front end of the coolant chamber and terminating at the front end of the drill, wherein the first coolant channel is associated with the first chip flute and the second coolant channel is associated with the second chip flute, wherein the coolant chamber includes a flow control element, which is movable between a neutral position, in which coolant flow is distributed substantially equally to the first and second coolant channels, and an active position, in which the flow control element directs the coolant flow at least mainly to one of said coolant channels, and that wherein the flow control element is arranged to move from said neutral position to said active position in response to a flow restriction in one of the first and second chip flutes, such that the coolant is directed at least mainly to the one coolant channel associated with the chip flute having a flow restriction.

2. The drill according to claim 1, wherein the flow control element is arranged to automatically move from the neutral position to an active position when there is a pressure difference in the coolant between the first and the second coolant channel.

3. The drill according to claim 1, wherein the flow control element moves back to the neutral position when the flow restriction in one of the chip flutes is removed.

4. The drill according to claim 1, wherein the flow control element is entirely mechanical.

5. The drill according to claim 1, wherein the flow control element is positioned between the rearward axial extensions of the first and second coolant channel when the flow control element is in the neutral position.

6. The drill according to claim 1, wherein the flow control element is a pendulum rotatable around an axle.

7. The drill according to claim 6, wherein the pendulum is hinged to the axle by a hole at the rear end of the pendulum and wherein the axle is partially threaded and fastened to the shank by a threaded hole in the shank.

8. The drill according to claim 7, wherein the hole in the shank is positioned on the rotation axis, perpendicular to the rotation axis and perpendicular to a line passing through the center of the first coolant channel and the center of the second coolant channel at the rear ends of the first and second coolant channel.

9. The drill according to claim 6, wherein the coolant chamber, in a cross-section perpendicular to the rotation axis, has a width that is approximately equal to the distance between the radially outermost parts of the rear ends of the first and second coolant channels.

10. The drill according to claim 6, wherein the coolant chamber, in a cross-section perpendicular to the rotation axis, has a thickness that is approximately equal to the diameter of the first and second coolant channels at the rear ends of the first and second coolant channels.

11. The drill according to claim 6, wherein the pendulum has its front end approximately located at the front end of the coolant chamber.

12. The drill according to claim 6, wherein the cross-sectional area of the front end of the pendulum is larger than the cross-sectional area of either of the first and the second coolant channel at the rear ends of the first and second coolant channel.

13. The drill according to claim 10, wherein the pendulum has a thickness that is approximately equal to the thickness of the coolant chamber.

14. The drill according to claim 1, wherein the drill has two axially extending arms at its front end, the arms being spaced apart about the rotation axis so as to define a jaw, and wherein the cutting insert is releasably mounted within the jaw between the arms.

15. The drill according to claim 1, wherein the drill has a central cutting insert releasably mounted in an insert seat at the front end of the drill and a peripheral cutting insert releasably mounted in an insert seat at the front end of the drill.
